(19) United States
(12) Patent Application Publication
(10) Pub. No.: US 2008/0028616 A1
(43) Pub. Date: Feb. 7, 2008

(54) SHAVER WITH LIGHTING MEANS

(76) Inventor: Dong Shin KWAK, Incheon (KR)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/829,485

(22) Filed: Jul. 27, 2007

(30) Foreign Application Priority Data
Aug. 2, 2006 (KR) 10-2006-0072870

(51) Int. Cl. B26B 21/46

(52) U.S. Cl. 30/32; 362/115

(57) ABSTRACT

The present invention provides a shaver with a lighting means, of which a head portion is formed with a shape of a vehicle front portion so that light is irradiated from a lighting means, e.g. from headlights that the vehicle front portion has, to a shaving surface of a user, thus providing safety and convenience when shaving. The lighting means integrally included in the shaver of the invention is provided in the form of vehicle headlights, thus creating a visual effect and increasing the value of commodities.

### CROSS-REFERENCE TO RELATED APPLICATION

This application claims the benefit of Korean Patent Application No. 10-2006-0072870, filed on Aug. 2, 2006, the entire disclosure of which is hereby incorporated by reference.

### BACKGROUND OF THE INVENTION

1. Field of the Invention

The present invention relates to a shaver with a lighting means and, more particularly, to a shaver with a lighting means provided on a head portion thereof to light a shaving surface, thus providing safety and convenience when shaving. The lighting means integrally included in the shaver of the invention is provided in the form of vehicle headlights, thus creating a visual effect and increasing the value of commodities.

2. Description of Related Art

In general, a shaver is a kind of cosmetic tools for shaving body hair such as beard, mustache, and whiskers.

Such a shaver includes a handle for grasping the shaver and a head portion coming in contact with skin while shaving. The handle and the head portion are formed integrally with each other. The head portion mounts a cartridge generally including two razor blades, in which one razor blade first shaves facial hair grown long and the other razor blade shaves the shaven facial hair shorter again, thus cleanly shaving the face.

When the razor blades mounted in a plastic housing of the disposable cartridge become dull in use, the corresponding cartridge is removed from the head portion and a new cartridge is mounted on the head portion.

The shaving operation is typically performed under a light environment; however, sometimes the shaving operation is carried out under a dark environment, if necessary.

In this case, since it is difficult to distinguish the shaving surface under the dark environment, the skin surface or the face may be damaged, if not paying careful attention.

In order to solve the above problem, various types of shavers with a lighting means have been proposed.

However, since the lighting means are inappropriately positioned in the conventional shavers, the light irradiated from the lighting means is interfered with a cartridge and thereby they cannot provide a sufficient light intensity to the shaving surface. Moreover, the lighting means are separately provided to protrude from the shavers thereby causing an inconvenience in use. In particular, since most lighting means are attached to the shavers as a separate part, the overall shapes of the conventional shavers are somewhat coarse and have a lack of merchantability. Accordingly, the conventional shavers have not been put to practical use.

### SUMMARY OF THE INVENTION

Accordingly, the present invention has been made in an effort to solve the above problems, and an object of the present invention is to provide a shaver with a lighting means provided on a head portion thereof to light a shaving surface, thus providing safety and convenience when shaving. The lighting means integrally included in the shaver of the invention is provided in the form of vehicle headlights, thus creating a visual effect and increasing the value of commodities.

In accordance with an aspect of the present invention, there is provided a shaver with a lighting means including: a head portion; and a handle, the head portion being provided with a lighting lamp lighting a shaving surface.

Preferably, the head portion is formed with a shape of a vehicle front portion and the lighting lamp is headlights that the vehicle front portion has.

Suitably, the shape of the vehicle front portion that the head portion has includes headlights, a radiator grill, a bumper, a hood, and a front glass.

Moreover suitably, the head portion is formed with an animal's head shape and the lighting lamp is eyes that the animal's head shape has.

### BRIEF DESCRIPTION OF THE DRAWINGS

The above and other features of the present invention will be described with reference to certain exemplary embodiments thereof illustrated the attached drawings in which:

FIG. 1 is an exploded perspective view showing a shaver with a lighting means in accordance with a preferred embodiment of the present invention;

FIG. 2 is an assembled perspective view showing the shaver with a lighting means in accordance with the preferred embodiment of the present invention; and

FIG. 3 is a diagram illustrating the use of the shaver with a lighting means in accordance with the preferred embodiment of the present invention.

### DETAILED DESCRIPTION OF THE INVENTION

Hereinafter, preferred embodiments in accordance with the present invention will be described with reference to the accompanying drawings. The preferred embodiments are provided so that those skilled in the art can sufficiently understand the present invention, but can be modified in various forms and the scope of the present invention is not limited to the preferred embodiments.

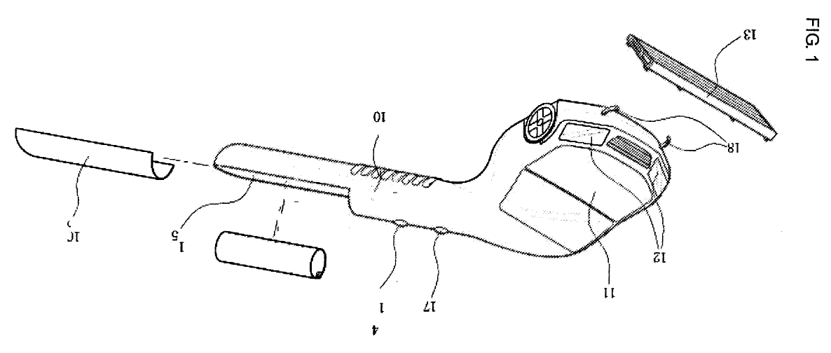

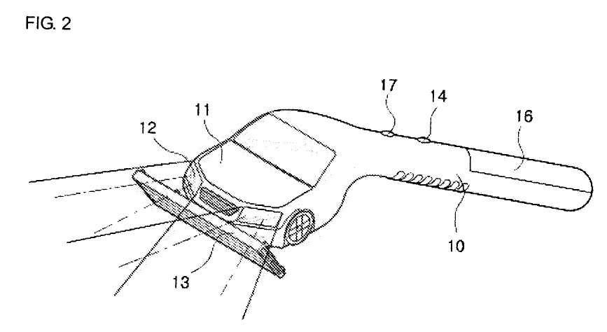

FIGS. 1 and 2 are perspective views showing a shaver with a lighting means in accordance with a preferred embodiment of the present invention.

As shown in FIGS. 1 and 2, the shaver includes a handle 10 and a head portion 11. A cartridge 13 including razor blades is mounted on the head portion 11.

The cartridge 13 is a disposable cartridge having a plastic housing in which razor blades are mounted and has a structure that can be attached and detached in an ordinary manner.

For example, if a user operates a cartridge button 17 provided on the handle 10, holders 18 provided on the head portion 11 are clamped or unclamped to hold or release the cartridge 13, thus easily replace the cartridge 13 having razor blades which have become dull in use with a new one.

In particular, the present invention provides a head portion 11 of a new type which has not yet been applied to the shaver.

The head portion 11 of the invention has a shape of a vehicle front portion including headlights, a radiator grill, a bumper, a hood, a front glass, front wheels, and front fenders.

The shape of the vehicle front portion that the head portion 11 has may include the headlights, the hood and the front glass only.

Moreover, as another embodiment of the present invention, the head portion 11 may be formed with an animal's head shape. In this case, the animal may include mammals, fishes, birds, and the like.

The shaver of the present invention includes a lighting means lighting a shaving surface. The lighting means may include a shape formed using the various shapes that the head portion 11 has.

For example, the head portion 11 is formed with the shape of the vehicle front portion and a lighting lamp 12 lighting the shaving surface is formed with a shape of headlights that the vehicle front portion has.

That is, the shaver of the invention irradiates light from the lighting means corresponding to the vehicle headlights.

In this case, the lighting lamp 12 may be realized by an ordinary light bulb, an LED, and the like. Moreover, it is possible to provide a sterilizing effect using an ultraviolet lamp.

As the concept of the headlights, which are lighting means of the vehicle, is introduced to the shaver, it is possible to provide a sense of unity between the lighting means and the shaver, differently from the conventional shavers with lighting means attached as a separate part. That is, it is possible to realize a structure in which the lighting means is naturally provided on the shaver and occupies a portion of the shaver. Moreover, the present invention provides a creative visual effect to the user by reproducing the intrinsic function of the vehicle headlights.

Meanwhile, the handle 10 of the shaver in accordance with the present invention further includes a lighting button 14 provided to turn on and off the lighting lamp 12, a battery receiving portion 15 in which a battery is received, and a cover 16 covering the battery receiving portion 15.

In this case, the cover 16 may be mounted in an ordinary manner to be closed or opened using a securing means such as a clip.

Here, as a method of forming a circuit for turning on and off the lighting lamp 12 by the operation of the lighting button 14, any method that is known to one skilled in the art may be used without limitation.

Moreover, as a further embodiment of the present invention, if the head portion 11 is formed with the animal's head shape, the lighting lamp 12 may be realized by animal eyes.

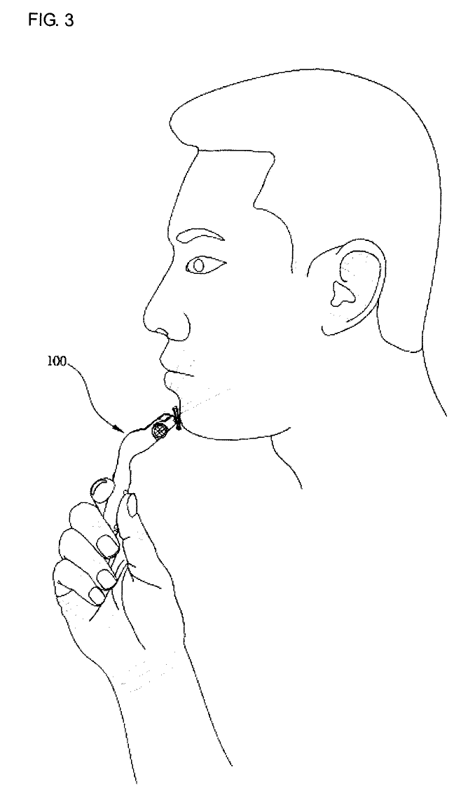

FIG. 3 is a diagram illustrating the use of the shaver with a lighting means in accordance with the preferred embodiment of the present invention.

As shown in FIG. 3, in a case where the shaving operation is performed under a dark environment or under a condition where a sufficient light is not provided, if the lighting button provided on the shaver 100 is pressed down, light is irradiated from the lighting means, e.g., from the headlights that the vehicle front portion has, to light the shaving surface directly. Accordingly, the user can perform the shaving operation more safely and conveniently.

As described above, the present invention provides a shaver of a new type, of which a head portion is formed with a shape of a vehicle front portion so that light is irradiated from a lighting means, e.g. from headlights that the vehicle front portion has, to a shaving surface of a user, thus providing safety and convenience when shaving. The lighting means integrally included in the shaver of the invention is provided in the form of vehicle headlights, thus creating a visual effect and increasing the value of commodities.

As above, preferred embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

What is claimed is:

1. A shaver with a lighting means, comprising:
a head portion; and
a handle,
the head portion being provided with a lighting lamp lighting a shaving surface.

2. The shaver with a lighting means of claim 1, wherein the head portion is formed with a shape of a vehicle front portion and the lighting lamp is headlights that the vehicle front portion has.

3. The shaver with a lighting means of claim 2, wherein the shape of the vehicle front portion that the head portion has includes headlights, a radiator grill, a bumper, a hood, and a front glass.

4. The shaver with a lighting means of claim 1, wherein the head portion is formed with an animal's head shape and the lighting lamp is eyes that the animal's head shape has.

5. The shaver with a lighting means of claim 1, wherein the lighting lamp comprises an ultraviolet lamp that provides a sterilizing effect.
